(19) United States
(12) Patent Application Publication
(10) Pub. No.: US 2007/0104082 A1
(43) Pub. Date: May 10, 2007

(54) Optical disk medium

(76) Inventor: Koji Nishida, Osaka (JP)

Correspondence Address: MCDERMOTT WILL & EMERY LLP, 600 13TH STREET, N.W., WASHINGTON, DC, 20005-3096, US

(21) Appl. No.: 11/584,517

(22) Filed: Oct. 23, 2006

(30) Foreign Application Priority Data
Nov. 9, 2005 (JP) 2005-325058

(51) Int. Cl. G11B 7/24

(52) U.S. Cl. 369/275.3

(57) ABSTRACT

In a hybrid optical disk medium has data recording surfaces at both sides thereof, one of which is a first recording surface and the other is a second recording surface, a removable first label representing “HDDVD” and “NO DVD” to identify the disk format of the second recording surface is attached to a region outside a disk clamping region on the disk surface of the first recording surface, and a removable second label representing “DVD” and “NO HDDVD” to identify the disk format of the first recording surface is attached to a region outside the disk clamping region on the disk surface of the second recording surface.

### CROSS-REFERENCE TO RELATED APPLICATION

The disclosure of Japanese Patent Application No. 2005-325058 filed on Nov. 9, 2005 including specification, drawings and claims is incorporated herein by reference in its entirety.

### BACKGROUND OF THE INVENTION

The present invention relates to optical disk media each having recording surfaces conforming to different disk formats at both sides thereof. In particular, the present invention relates to a technique for allowing a user to identify which surface of an optical disk medium conforms to a disk format the user wants to use.

In recent years, a DVD-ROM disk which has a double-layer structure at either side and whose one side is a high definition DVD (HDDVD) with a recording capacity of 30 GB and another side has a recording capacity of 8.5 GB has been developed as a hybrid optical disk medium. When a user loads such a disk into a DVD player, the user needs to know which side of the disk is a DVD-ROM playback side without fail. However, means for this has not been provided yet.

### SUMMARY OF THE INVENTION

However, if a label for identifying a disk format is printed on a disk surface in order to identify the disk format, no laser beam passes through the printed portion, so that no information playback signal is read out.

Accordingly, it is difficult for a user to identify which side conforms to a disk format the user wants to read out.

It is therefore an object of the present invention to ensure identification of a recording surface conforming to a disk format a user wants to read out.

Specifically, according to the present invention, a hybrid optical disk medium having data recording surfaces at both sides thereof, one of the data recording surfaces being a first recording surface and the other being a second recording surface, wherein a removable first label representing identification information indicating a disk format of an information playback signal read out from the second recording surface is attached to a disk surface of the first recording surface, and a removable second label representing identification information indicating a disk format of an information playback signal read out from the first recording surface is attached to a disk surface of the second recording surface.

With this configuration, according to the present invention, a user is allowed to peel off a label attached to a disk surface, while leaving a label on the other side representing information such as the name, a logo or a symbol of a disk format the user wants to use. Then, the hybrid optical disk medium comes to a state which is the same as a general single-sided disk. Accordingly, the user does not load the optical disk medium into playback apparatus such as a DVD player in a wrong direction, thus enhancing convenience to the user.

If the first recording surface conforms to a DVD format using a red laser and the second recording surface conforms to an HDDVD format using a blue laser, for example, it is preferable that the color of the first label is blue, which is the same as that of the HDDVD format, and the second label is red, which is the same as that of the DVD format. This is because the disk formats are visually identified and identification ability is further enhanced.

The first label and the second label may be of the same shape and symmetric with respect to a rotation center of the optical disk medium. Then, mass unbalance resulting from the attached positions of the first and second labels between the first recording surface and the second recording surface is eliminated, so that the unbalanced load of the optical disk medium is minimized. Accordingly, occurrence of vibration during high-speed rotation of the optical disk medium is suppressed.

Each of the first and second labels may be attached to a region of disk surface other than a disk clamping region. Then, it is possible to prevent a disk clamper and the labels from being in contact with each other during playback, thus obtaining advantages in suppressing peeling of the labels.

In the optical disk medium, label display indicating a disk format may be printed within a disk clamping region that does not affect reading with a laser beam. Accordingly, the step of peeling a label from one side is unnecessary.

If the disk format of a disk surface represented within the disk clamping region is displayed on a display layer sandwiched between the first and second recording surfaces, a disk clamper and the display portion of the disk surface are not in contact with each other, so that deterioration of display with use over time is avoided.

The disk format may be represented by a dent/bump character formed on a disk surface. Then, attachment of labels and printing are unnecessary. This is advantageous in enhancing convenience to a user.

The optical disk medium may be configured such that the first label also represents denial of the disk format of an information playback signal read out from the first recording surface and the second label also represents denial of the disk format of an information playback signal read out from the second recording surface. Then, the user easily finds that the optical disk medium is a hybrid optical disk medium capable of being read from both sides thereof and readily identifies two different disk formats by seeing a label at one side.

As descried above, according to the present invention, a user is allowed to peel off a label attached to a disk surface, while leaving a label on the other side representing information such as the name, a logo or a symbol of a disk format the user wants to use. Then, the hybrid optical disk medium comes to a state which is the same as a general single-sided disk. Accordingly, the user does not load the optical disk medium into playback apparatus such as a DVD player in a wrong direction, thus enhancing convenience to the user.

### BRIEF DESCRIPTION OF THE DRAWINGS

FIG. 1 is a cross-sectional view schematically illustrating a structure of an optical disk medium according to a first embodiment of the present invention.

FIG. 2 is a plan view of the optical disk medium of the first embodiment when viewed from a first recording surface.

FIG. 3 is a plan view of the optical disk medium of the first embodiment when viewed from a second recording surface.

FIG. 4 is a perspective view illustrating a modification of the optical disk medium of the first embodiment.

FIG. 5 is a plan view illustrating an optical disk medium according to a second embodiment of the present invention when viewed from a first recording surface.

FIG. 6 is a plan view of the optical disk medium of the second embodiment when viewed from a second recording surface.

FIG. 7 is a cross-sectional view schematically illustrating a structure of an optical disk medium according to a third embodiment of the present invention.

FIG. 8 is a plan view of the optical disk medium of the third embodiment when viewed from a first recording surface.

FIG. 9 is a plan view illustrating an optical disk medium according to a fourth embodiment of the present invention when viewed from a first recording surface.

FIG. 10 is a plan view of the optical disk medium of the fourth embodiment when viewed from a second recording surface.

### DETAILED DESCRIPTION OF THE INVENTION

Hereinafter, embodiments of the present invention will be specifically described with reference to the drawings. The following embodiments are merely exemplary in nature and are not intended to limit the invention, application and the use thereof.

### Embodiment 1

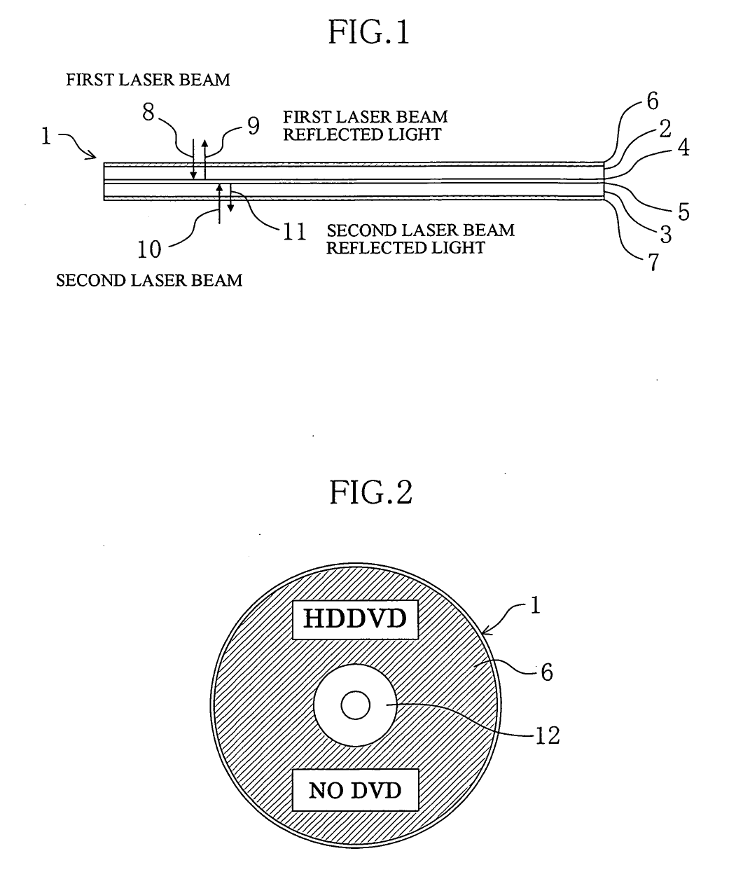

FIG. 1 is a cross-sectional view schematically illustrating a structure of an optical disk medium according to a first embodiment of the present invention. As illustrated in FIG. 1, the optical disk medium 1 is a hybrid disk including data recording surfaces at both sides, one of which is a first recording surface 2 and the other is a second recording surface 3.

The optical disk medium 1 includes: a first reflector layer 4 for reflecting a first laser beam 8 coming from the first recording surface 2 and outputting first laser beam reflected light 9; and a second reflector layer 5 for reflecting a second laser beam 10 coming from the second recording surface 3 and outputting second laser beam reflected light 11.

The optical disk medium 1 of the first embodiment is a so-called hybrid disk as a combination of a DVD and an HDDVD. It is assumed that the first reflector layer 4 conforms to a DVD disk format and the second reflector layer 5 conforms to an HDDVD disk format.

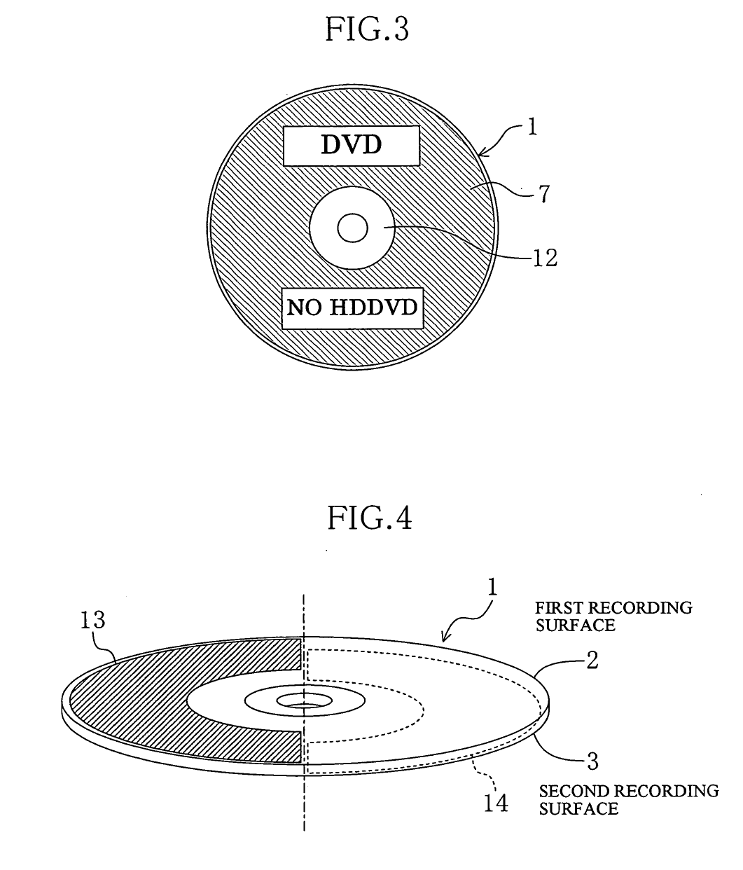

FIG. 2 is a plan view of the optical disk medium 1 of the first embodiment when viewed from the first recording surface 2. FIG. 3 is a plan view of the optical disk medium 1 when viewed from the second recording surface 3.

A removable first label 6 representing “HDDVD” and “NO DVD” to identify the disk format of the second recording surface 3 is attached to a region outside a disk clamping region 12 on the disk surface of the first recording surface 2.

A removable second label 7 representing “DVD” and “NO HDDVD” to identify the disk format of the first recording surface 2 is attached to a region outside the disk clamping region 12 on the disk surface of the second recording surface 3.

In the first embodiment, the first and second labels 6 and 7 represent the names of standards indicating the respective disk formats. However, the present invention is not limited to this. For example, logos, symbols or others for identification may be represented.

Now, a procedure of using the optical disk medium 1 of the first embodiment will be described. First, the user looks at the first and second labels 6 and 7 attached to both sides of the disk and knows which side conforms to a disk format the user wants to use.

Specifically, when the user wants to use the HDDVD, the user peels off the second label 7 representing “DVD” and “NO HDDVD” attached to the disk surface of the second recording surface 3, while leaving the first label 6 representing “HDDVD” and “NO DVD” attached to the disk surface of the first recording surface 2 at the other side.

Then, the optical disk medium 1 comes to a state which is the same as a general single-sided disk. Accordingly, the user does not load the optical disk medium 1 into playback apparatus such as a DVD player in a wrong direction, thus enhancing convenience to the user.

In addition, since the first and second labels 6 and 7 are attached to the disk surfaces in regions other than the disk clamping region 12, it is possible to prevent a disk clamper and the labels from being in contact with each other during playback, thus obtaining advantages in suppressing peeling of the labels.

If the first recording surface 2 conforms to a DVD format using a red laser and the second recording surface 3 conforms to an HDDVD format using a blue laser as in the first embodiment, it is preferable that the color of the first label 6 is blue, which is the same as that of the HDDVD format, and the second label 7 is red, which is the same as that of the DVD format. This is because the disk formats are visually identified and identification ability is further enhanced. The same holds for the following embodiments.

FIG. 4 is a view illustrating a modification of the labels attached to the first and second recording surfaces 2 and 3. As illustrated in FIG. 4, a semi-arc first label 13 is attached to the disk surface of the first recording surface 2 and a second label 14 in the same shape as the first label 13 is attached to the disk surface of the second recording surface 3 at a position symmetric with respect to the first label 13 about the rotation center of the disk. The first and second labels 13 and 14 are removable from the disk surfaces.

Then, mass unbalance resulting from the attached positions of the first and second labels 13 and 14 between the first recording surface 2 and the second recording surface 3 is eliminated, so that the unbalanced load of the optical disk medium 1 is minimized. Accordingly, occurrence of vibration during high-speed rotation of the optical disk medium 1 is suppressed.

### Embodiment 2

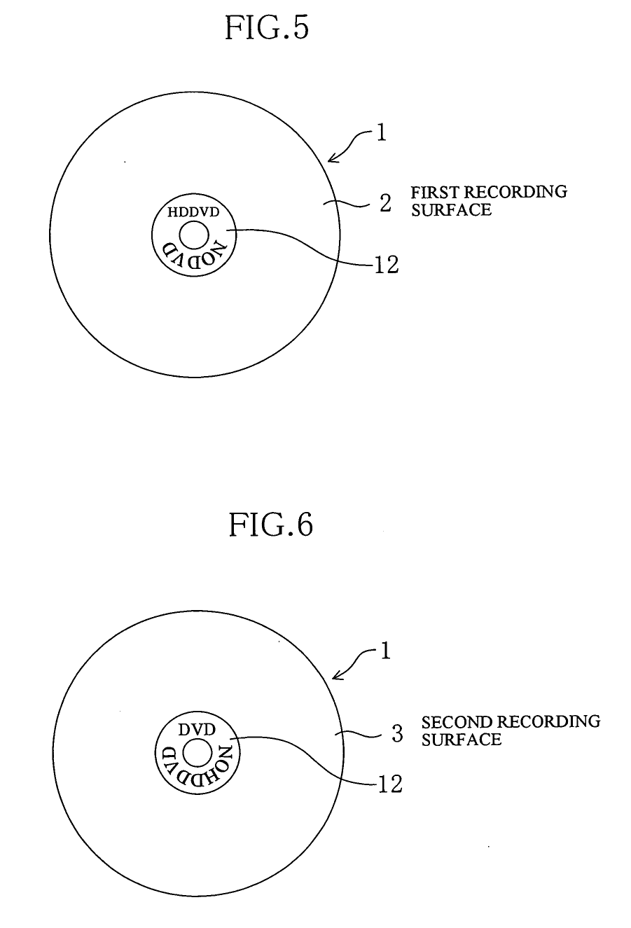

FIG. 5 is a plan view illustrating a structure of an optical disk medium according to a second embodiment of the present invention. The second embodiment is different from the first embodiment only in the structures of the first and second labels. Therefore, components already described in the first embodiment are denoted by the same reference numerals and only different aspects will be described. The same holds for the following embodiments.

FIG. 5 is a plan view of the optical disk medium when viewed from a first recording surface. FIG. 6 is a plan view of the optical disk medium when viewed from a second recording surface. As illustrated in FIGS. 5 and 6, “HDDVD” and “NO DVD” are printed on a disk clamping region of the first recording surface 2 so as to identify the disk format of the second recording surface 3, whereas “DVD” and “NO HDDVD” are printed on a disk clamping region of the second recording surface 3 so as to identify the disk format of the first recording surface 2.

As described above, in the optical disk medium of the second embodiment, the labels representing the disk formats are printed only within the disk clamping regions 12 that do not affect reading with a laser beam. Accordingly, unlike the first embodiment, the step of peeling a label from a disk surface is unnecessary.

### Embodiment 3

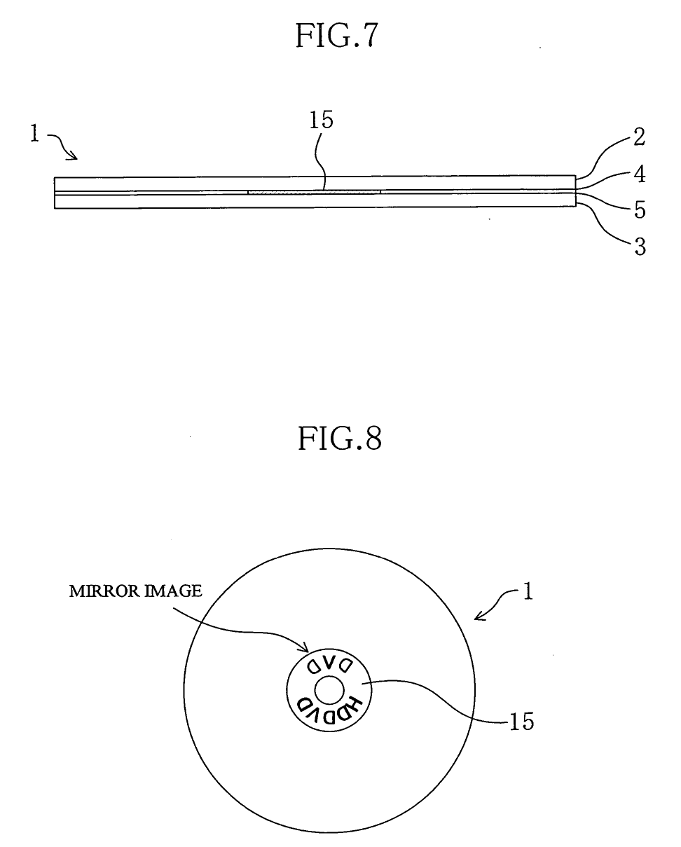

FIG. 7 is a cross-sectional view schematically illustrating a structure of an optical disk medium according to a third embodiment of the present invention. As illustrated in FIG. 7, a transparent display layer 15 is provided at the position corresponding to a disk clamping region in such a manner that the display layer 15 is sandwiched between a first recording surface 2 and a second recording surface 3.

FIG. 8 is a plan view of the optical disk medium when viewed from the first recording surface. As illustrated in FIG. 8, “HDDVD” and a mirror image of “DVD” are printed on the display layer 15 when viewed from the first recording surface 2.

On the other hand, when viewed from the second recording surface 3, “DVD” and a mirror image of “HDDVD” are printed on the display layer 15.

As described above, in the optical disk medium of the third embodiment, when viewed from the first recording surface 2, it is found that the backside second recording surface 3 conforms to the HDDVD disk format, whereas when viewed from the second recording surface 3, the backside first recording surface 2 conforms to the DVD disk format.

In addition, since the disk formats of the disk surfaces within the disk clamping region 12 are represented on the display layer 15 sandwiched between the first and second recording surfaces 2 and 3, a disk clamper is not in contact with the display portions of the disk surfaces. Accordingly, deterioration of display with use over time is avoided.

### Embodiment 4

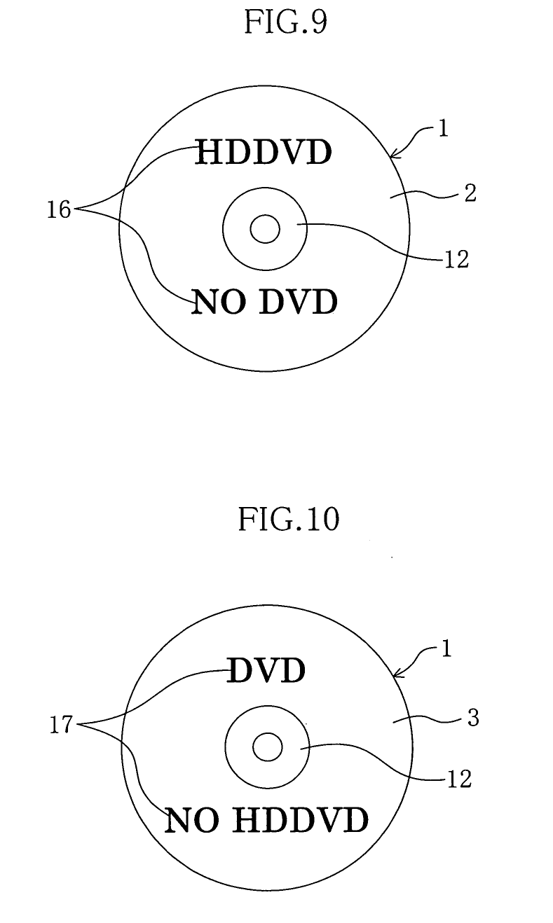

FIG. 9 is a plan view illustrating a structure of an optical disk medium according to a fourth embodiment of the present invention when viewed from a first recording surface. FIG. 10 is a plan view of the optical disk medium when viewed from a second recording surface.

As illustrated in FIG. 9, “HDDVD” and “NO DVD” are represented by characters 16 which are dents and/or bumps (hereinafter, referred to as dent/bump characters 16) and formed on the disk surface of the first recording surface 2 in a region outside a disk clamping region 12 so as to identify the disk format of the second recording surface 3.

On the other hand, “DVD” and “NO HDDVD” are represented by characters 17 which are dents and/or bumps (hereinafter, referred to as dent/bump characters 17) and formed on the disk surface of the second recording surface 3 in a region outside the disk clamping region 12 so as to identify the disk format of the first recording surface 2.

As described above, in the optical disk medium of the fourth embodiment, displays indicating the disk formats are represented by the dent/bump characters formed on the disk surfaces, so that attachment of labels and printing are unnecessary. This is advantageous in enhancing convenience to a user.

As described above, according to the present invention, high practical utility that ensures identification of the recording surface conforming to a disk format a user wants to use is obtained. Therefore, the present invention is very useful and has high industrial applicability. In particular, for playback apparatus capable of playing back two old and new disk formats, it is possible to load a recording surface conforming to the new disk format in a right direction. Accordingly, an optical disk medium according to the present invention is effective as an optical disk medium in a period of transition to a new disk format.

What is claimed is:

1. A hybrid optical disk medium having data recording surfaces at both sides thereof, one of the data recording surfaces being a first recording surface and the other being a second recording surface,
wherein a removable first label representing identification information indicating a disk format of an information playback signal read out from the second recording surface is attached to a disk surface of the first recording surface, and
a removable-second label representing identification information indicating a disk format of an information playback signal read out from the first recording surface is attached to a disk surface of the second recording surface.

2. The optical disk medium of claim 1, wherein the color of the first label differs from the color of the second label.

3. The optical disk medium of claim 1, wherein the first label and the second label are of the same shape and are symmetric with respect to a rotation center of the optical disk medium.

4. The optical disk medium of claim 1, wherein each of the first label and the second label is attached to a region outside a disk clamping region on the disk surface.

5. The optical disk medium of claim 1, wherein the identification information represented on the first recording surface includes information indicating the disk format of the second recording surface and information indicating denial of the disk format of the first recording surface, and
the identification information represented on the second recording surface includes information indicating the disk format of the first recording surface and information indicating denial of the disk format of the second recording surface.

6. A hybrid optical disk medium having data recording surfaces at both sides thereof, one of the data recording surfaces being a first recording surface and the other being a second recording surface,
wherein identification information indicating a disk format of an information playback signal read out from the second recording surface is represented on a disk clamping region of a disk surface of the first recording surface, and
identification information indicating a disk format of an information playback signal read out from the first recording surface is represented on a disk clamping region of a disk surface of the second recording surface.

7. The optical disk medium of claim 6, wherein a display layer is provided between the first recording surface and the second recording surface at a position corresponding to the disk clamping regions, and
the identification information indicating the disk formats are displayed on the display layer.

8. The optical disk medium of claim 6, wherein the identification information represented on the first recording surface includes information indicating the disk format of the second recording surface and information indicating denial of the disk format of the first recording surface, and
the identification information represented on the second recording surface includes information indicating the disk format of the first recording surface and information indicating denial of the disk format of the second recording surface.

9. A hybrid optical disk medium having data recording surfaces at both sides thereof, one of the data recording surfaces being a first recording surface and the other being a second recording surface,
wherein identification information indicating a disk format of an information playback signal read out from the second recording surface is represented by a dent/bump character on a disk surface of the first recording surface, and
identification information indicating a disk format of an information playback signal read out from the first recording surface is represented by a dent/bump character on a disk surface of the second recording surface.

10. The optical disk medium of claim 9, wherein the identification information represented on the first recording surface includes information indicating the disk format of the second recording surface and information indicating denial of the disk format of the first recording surface, and
the identification information represented on the second recording surface includes information indicating the disk format of the first recording surface and information indicating denial of the disk format of the second recording surface.
